(19) United States
(12) Patent Application Publication
(10) Pub. No.: US 2015/0046600 A1
(43) Pub. Date: Feb. 12, 2015

(54) METHOD AND APPARATUS FOR DISTRIBUTING DATA IN HYBRID CLOUD ENVIRONMENT

(71) Applicant: Samsung Electronics Co., Ltd., Suwon-si (KR)

(72) Inventor: Su-hyun KIM, Seoul (KR)

(21) Appl. No.: 14/445,729

(22) Filed: Jul. 29, 2014

(30) Foreign Application Priority Data
Aug. 8, 2013 (KR) 10-2013-0094322

(51) Int. Cl. H04L 29/08

(52) U.S. Cl. CPC H04L 67/1008
USPC 709/232

(57) ABSTRACT

A method of distributing data in a hybrid cloud environment is provided. The method includes receiving a request to execute a service from a client, analyzing service use pattern information of the client based on the received request to execute the service, estimating a work load of the service by using the analyzed service use pattern information, and distributing data related to the service based on the estimated work load.

### CROSS-REFERENCE TO RELATED APPLICATION(S)

This application claims the benefit under 35 U.S.C. §119(a) of a Korean patent application filed on Aug. 8, 2013 in the Korean Intellectual Property Office and assigned Serial number 10-2013-0094322, the entire disclosure of which is hereby incorporated by reference.

### TECHNICAL FIELD

The present disclosure relates to a method and apparatus for distributing data in a hybrid cloud environment. More particularly, the present disclosure relates to a method and apparatus for estimating a work load of a service based on a service use pattern of a client in a hybrid cloud environment and distributing data related to the service based on the estimated work load.

### BACKGROUND

A hybrid cloud environment refers to a network environment for effective management of data, which is operated by integrating a public cloud and a private cloud. In other words, a hybrid cloud refers to an open network that is highly extendable by connecting a public cloud and a private cloud so that computing, applications, data, and storage resources are efficiently moved between the public cloud and the private cloud.

In a hybrid cloud, a private cloud may be used to provide a service, such as personal computing, execution of an application, creation and/or editing of contents, and then a portion or all of data is moved to a public cloud to execute an operation requested by a client to thereby provide the client with high-degree data processing performance, and available resources may be efficiently utilized. That is, in the hybrid cloud environment, vast resources of the public cloud may be used to extend an operating environment via the private cloud.

In addition, in the hybrid cloud environment, in order to secure stability and reliability of data storage, important data is stored in a private cloud for use. In contrast, data with a relatively low importance is stored in the public cloud and then used according to need. That is, in the hybrid cloud environment, data may be respectively stored in the private cloud or the public cloud according to importance of the data to thereby further reinforce data security.

Recently, balancing of a work load needed in, for example, data processing has become important according to the integral operation of a public cloud and a private cloud in a hybrid cloud environment.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for distributing data in a hybrid cloud environment.

Additional aspects will be set forth in part in the description which follows and, in part, will be apparent from the description, or may be learned by practice of the presented various embodiments.

In accordance with an aspect of the present disclosure, a method of distributing data in a hybrid cloud environment is provided. The method includes receiving a request to execute a service from a client, analyzing service use pattern information of the client based on the received request to execute the service, estimating a work load of the service by using the analyzed service use pattern information, and distributing data related to the service based on the estimated work load.

In accordance with another aspect of the present disclosure, a method of distributing data according to selection by a client in a hybrid cloud environment is provided. The method includes outputting at least one additional service item that is available from a hybrid cloud server, selecting an additional service from among the outputted at least one additional service item based on an external input signal corresponding to the outputted at least one additional service item, and transmitting information about the selected additional service to the hybrid cloud server. The hybrid cloud server may distribute data based on the information received from the client.

In accordance with another aspect of the present disclosure, an apparatus for distributing data in a hybrid cloud environment is provided. The apparatus includes a receiver configured to receive a request to execute a service from a client, a pattern information analyzer configured to analyze service use pattern information of the client based on the received request to execute the service, a work load estimator configured to estimate a work load of the service by using the analyzed service use pattern information, and a data distributor configured to distribute data related to the service based on the estimated work load.

In accordance with another aspect of the present disclosure, a client providing an additional service related to data distribution on the side of a server in a hybrid cloud environment is provided. The client includes an output unit configured to output at least one additional service item that is available from a hybrid cloud server, an external input receiver configured to receive an external input signal corresponding to the outputted at least one additional service item, a selector configured to select an additional service from among the at least one additional service item based on the received external input signal, and a transmitter configured to transmit information about the selected additional service to the hybrid cloud server, wherein the data is distributed by the hybrid cloud server based on the information about the selected additional service.

In accordance with another aspect of the present disclosure, a non-transitory computer readable recording medium having embodied thereon a program for executing the method of described above is provided.

In accordance with another aspect of the present disclosure, a method of distributing data in a hybrid cloud environment including a public cloud and a private cloud is provided. The method includes receiving a request to execute a service from a client, analyzing service use pattern information of the client based on the received request to execute the service, estimating a work load of the service by using the analyzed service use pattern information, and distributing data related to the service between the public cloud and the private cloud based on the estimated work load, wherein the public cloud comprises a network service using a wide area network, and wherein the private cloud comprises a network service using a local area network.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view illustrating a method of distributing service-related data in a hybrid cloud environment based on a work load of a service according to an embodiment of the present disclosure;

FIG. 2 is a flowchart illustrating a method of distributing data in a hybrid cloud environment according to an embodiment of the present disclosure;

FIG. 3 illustrates a method of service analyzing use pattern information of a client according to an embodiment of the present disclosure;

FIG. 4 illustrates a method of estimating a work load of a service according to an embodiment of the present disclosure;

FIG. 5 illustrates a method of distributing service-related data based on an estimated work load according to an embodiment of the present disclosure;

FIG. 6 is a flowchart illustrating a method of reestimating a work load and redistributing service-related data based on the reestimated work load according to an embodiment of the present disclosure;

FIG. 7 illustrates a method of redistributing service-related data according to an embodiment of the present disclosure;

FIG. 8 is a flowchart illustrating a method of updating current position information of service-related data according to an embodiment of the present disclosure;

FIG. 9 illustrates a method of receiving a request to execute a service, from a client according to an embodiment of the present disclosure;

FIG. 10 illustrates a method of distributing service-related data based on a request to execute an additional service according to an embodiment of the present disclosure;

FIG. 11 is a flowchart illustrating a method of distributing data according to selection of a client in a hybrid cloud environment according to an embodiment of the present disclosure;

FIG. 12 illustrates an example of an additional service available via a client, in a hybrid cloud environment according to an embodiment of the present disclosure;

FIG. 13 is a block diagram illustrating an apparatus for distributing data in a hybrid cloud environment according to an embodiment of the present disclosure;

FIG. 14 is a block diagram illustrating an apparatus including a pattern information analyzer according to an embodiment of the present disclosure;

FIG. 15 is a block diagram illustrating an apparatus including a work load estimator according to an embodiment of the present disclosure;

FIG. 16 is a block diagram illustrating an apparatus including a data distributor according to an embodiment of the present disclosure;

FIG. 17 is a block diagram illustrating an apparatus including a position information updating unit according to an embodiment of the present disclosure; and

FIG. 18 is a block diagram illustrating a client that provides an additional service related to data distribution on the side of a server in a hybrid cloud environment according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, the terms used in the specification will be briefly described, and then the present disclosure will be described in detail.

The terms used in this specification are those general terms currently widely used in the art in consideration of functions in regard to the present disclosure, but the terms may vary according to the intention of those of ordinary skill in the art, precedents, or new technology in the art. Also, specified terms may be selected by the applicant, and in this case, the detailed meaning thereof will be described in the detailed description of the present disclosure. Thus, the terms used in the specification should be understood not as simple names but based on the meaning of the terms and the overall description of the present disclosure.

Throughout the specification, it will also be understood that when a component “includes” an element, unless there is another opposite description thereto, it should be understood that the component does not exclude another element but may further include another element. In addition, terms such as “ . . . unit”, “ . . . module”, or the like refer to units that perform at least one function or operation, and the units may be implemented as hardware or software or as a combination of hardware and software.

The present disclosure now will be described more fully hereinafter with reference to the accompanying drawings, in which illustrative various embodiments of the present disclosure are shown. This present disclosure may, however, be embodied in many different forms and should not be construed as limited to the various embodiments set forth herein, rather, these various embodiments are provided so that this disclosure will be thorough and complete, and will fully convey the scope of the present disclosure to those of ordinary skill in the art. Like numbers refer to like elements throughout.

As a large amount of data is processed in a hybrid cloud environment, the cloud environment should be continuously managed so that a work load generated for each user and each service is the smallest, or in other words, in minimized.

According to an embodiment of the present disclosure, a work load for each user or service may be obtained, and a position, or in other words, a location, of a cloud where a service requested by a user is to be executed may be designated based on the obtained work load to thereby prevent excessive concentration of the work load in the hybrid cloud environment. That is, network traffic between data centers, such as a private cloud and a public cloud, may be reduced as much as possible based on the work load that is obtained for each user or service, thereby quickly adjusting the work load between the private cloud and the public cloud in real time.

Also, according to an embodiment of the present disclosure, a user and/or a client may be allowed to directly select an environment condition of a cloud where a service is to be executed, thereby improving use convenience of a user who uses a hybrid cloud.

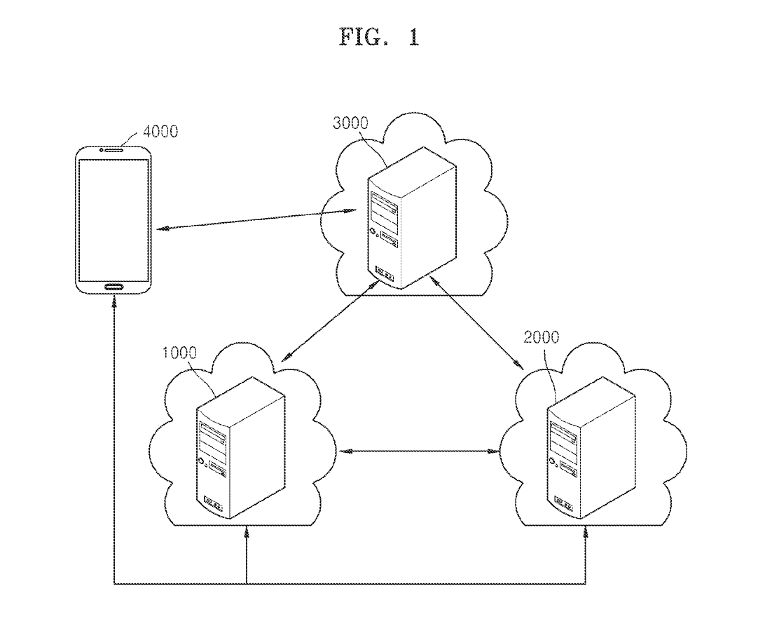

FIG. 1 is a schematic view illustrating a method of distributing service-related data in a hybrid cloud environment based on a work load of a service according to an embodiment of the present disclosure.

Referring to FIG. 1, the hybrid cloud environment may include a hybrid cloud controlling apparatus 3000, which may also be referred to as a data distributing apparatus 3000, at least one private cloud server 1000, and at least one public cloud server 2000.

The hybrid cloud controlling apparatus 3000, the at least one private cloud server 1000, and the at least one public cloud server 2000 may be connected to one another in a wired and/or wireless manner. Also, the hybrid cloud controlling apparatus 3000, the at least one private cloud server 1000, and the at least one public cloud server 2000 may be connected to a user and/or a client in a wired and/or wireless manner.

A client 4000 according to an embodiment of the present disclosure may be a mobile phone, a smart phone, a desktop computer, a laptop computer, a tablet Personal Computer (PC), an electronic-book (e-book) terminal, a Personal Digital Assistant (PDA), a Portable Multimedia Player (PMP), a navigation device, or any other similar and/or suitable electronic device.

Also, the client 4000 may be various devices having a display function such as a smart Television (TV), an Internet Protocol Television (IPTV), a Digital Television (DTV), a digital broadcasting terminal, a Consumer Electronic (CE) device, e.g., a refrigerator, an air-conditioner having a display panel, and other similar consumer electronic devices, or any other similar and/or suitable electronic devices having a display function.

The hybrid cloud controlling apparatus 3000, which has received a request to execute a predetermined service from the client 4000, may calculate a work load of the service which is requested to be executed, and move service-related data between a private cloud server and a public cloud server such that the service is executed on a cloud server having a relatively small work load from among the at least one private cloud server 1000 and the at least one public cloud server 2000.

That is, service-related data is moved such that a service requested to be executed may be executed in a server including and/or having more available resources, thereby improving utility efficiency of resources in the hybrid cloud environment.

In addition, as a service may be provided via a server with a relatively small work load, service latency may be reduced overall.

In addition, an increased amount of transmission and/or reception data traffic between a private cloud and a public cloud may be reduced, thereby reducing operational costs of the hybrid cloud environment.

In addition, according to an embodiment of the present disclosure, the client 4000 is allowed to select an additional service to be provided in the hybrid cloud environment, and to modify an operational state of the hybrid cloud according to the selected additional service, thereby improving use convenience of the hybrid cloud for the client.

For example, the additional service may include a service regarding at least one of selection of a security level of the private cloud server 1000 or the public cloud server 2000, selection of a position of, or in other words, a location of, or a selection between the private cloud server 1000 or the public cloud server 2000 where a service is to be executed, selection of a number of pieces of duplicate data in the private cloud server 1000 and/or the public cloud server 2000, selection of performance of a server of the private cloud server 1000 and/or the public cloud server 2000 where a service is to be executed, and selection of a network speed, for example, a speed of at least one of a network between the client 4000 and the private cloud server 1000, a network between the client 4000 and the public cloud server 2000, and a network between the private cloud server 1000 and the public cloud server 2000.

In other words, various requests by the client 4000 may be met by modifying an operational status of the hybrid cloud according to selection of the client 4000.

Also, according to an embodiment of the present disclosure, a method of distributing data in a hybrid cloud environment including a public cloud and a private cloud is provided. The method may include receiving a request to execute a predetermined service from a client, analyzing service use pattern information of the client based on the received request to execute a service, estimating a work load of the service by using the analyzed information, and distributing data related to the service between the public cloud and the private cloud based on the estimated work load.

According to an embodiment of the present disclosure, the public cloud may include a network service using a wide area network, and the private cloud may include a network service using a local area network. For example, the wide area network may include the Internet. Also, the local area network may include the intranet.

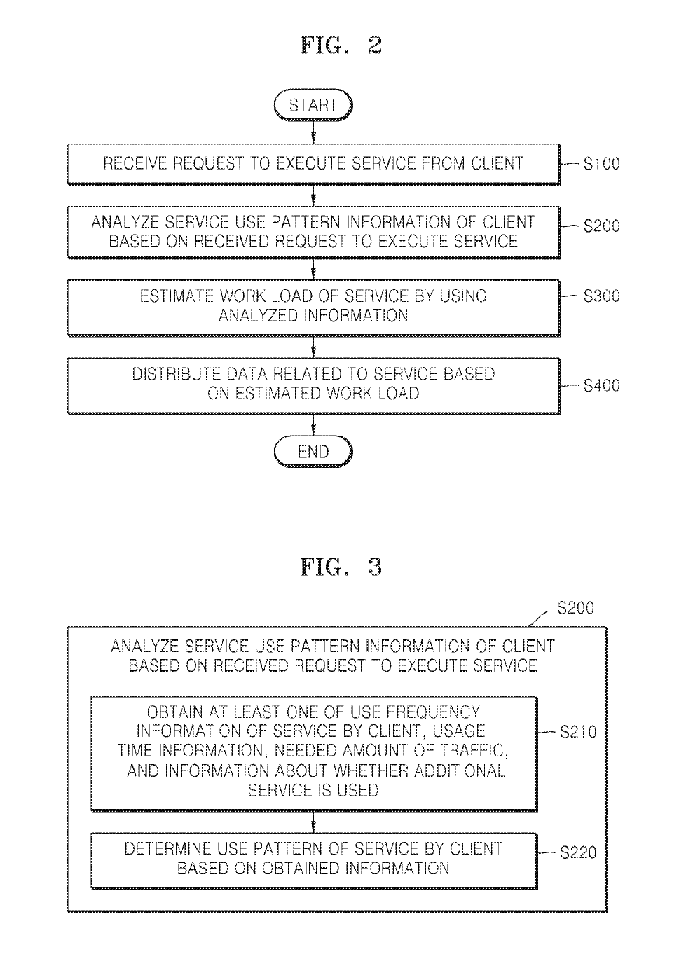

FIG. 2 is a flowchart illustrating a method of distributing data in a hybrid cloud environment according to an embodiment of the present disclosure.

Referring to FIG. 2, the method of distributing data in a hybrid cloud environment according to an embodiment of the present disclosure may include operation S100 of receiving a request to execute a service from a client, operation S200 of analyzing service use pattern information of the client based on the received request to execute the service, operation S300 of estimating a work load of the service by using the analyzed information, and operation S400 of distributing data related to the service based on the estimated work load.

For example, the hybrid cloud controlling apparatus 3000 may receive a request to execute a service from the client 4000, in operation S100.

The hybrid cloud controlling apparatus 3000 may analyze service use pattern information of the client based on the received request to execute the service in operation S200. The hybrid cloud controlling apparatus 3000 may analyze use frequency information of the service by the client, usage time information, a needed amount of traffic, and information about whether an additional service is used.

The hybrid cloud controlling apparatus 3000 may estimate a work load of the service that is requested by the client 4000 to be executed, by using, for example, a service use pattern of the client 4000 in operation S300. The work load may be estimated based on at least one of a number of users who have requested a corresponding service to be executed, a number of resources to be used to execute a service, and usage time of the resources. Also, the work load may be estimated based on a ratio of an available resource to a total resource of the public cloud server 2000 when the requested service is being executed. Also, the work load may be estimated based on a ratio of an available resource of the private cloud server 1000 to a total resource when the requested service is being executed.

Also, service-related data may be distributed and/or migrated based on the estimated work load in operation 400. As described above, the service-related data may be moved such that the service may be executed in a server currently having a relatively small work load from among the private cloud server 1000 and the public cloud server 2000. The service-related data according to the current embodiment of the present disclosure may include a Virtual Machine (VM). The VM may refer to a software container formed of an Operating System (OS) and an application program. For example, the VM may operate like a physical computer, and may include virtual resources, e.g., a virtual Central Processing Unit (vCPU), virtual Memory (vMem), a virtual Disk (vDisk), and a virtual Network Interface Controller (vNIC).

FIG. 3 illustrates a method of analyzing service use pattern information of a client according to an embodiment of the present disclosure.

Referring to FIG. 3. operation S200 of the analyzing of the service use pattern information of the client based on the received request to execute the service may include operation S210 of obtaining at least one of use frequency information of the service by the client, usage time information, a needed amount of traffic, and information about whether an additional service is used, and operation S220 of determining a use pattern of the service by the client 4000 based on the obtained information.

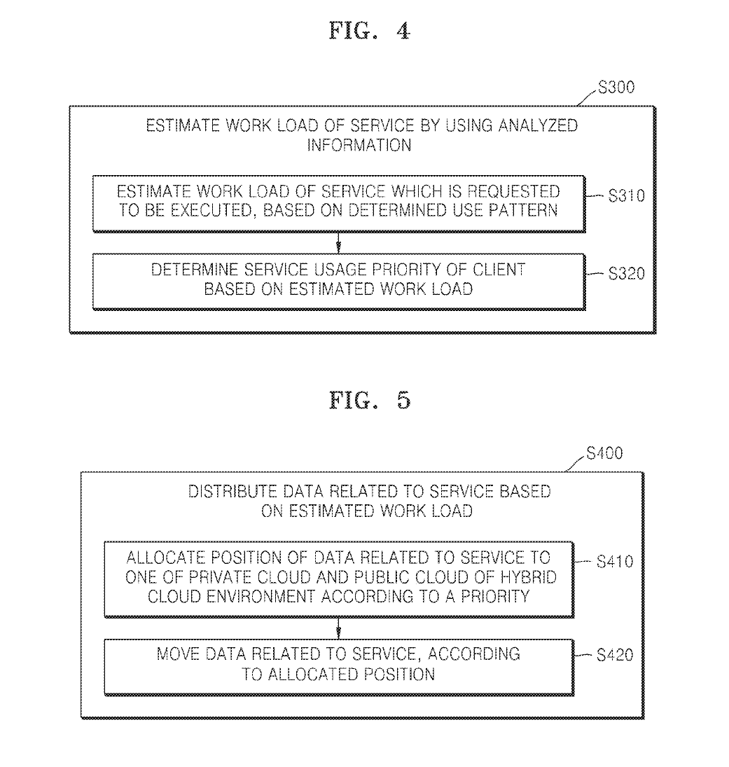

FIG. 4 illustrates a method of estimating a work load of a service according to an embodiment of the present disclosure.

Referring to FIG. 4, operation S300 of the estimating of the work load of the service by using the analyzed information may include operation S310 of estimating a work load of the service which is requested to be executed, based on the determined use pattern, and operation S320 of determining a service usage priority of a client based on the estimated work load.

For example, for a higher and/or increasing frequency that a client 4000 uses a service, an estimate of a work load may be respectively higher and/or increased. Also, the longer the client 4000 uses a service, a higher work load of the service may be estimated. Also, when a needed amount of traffic in executing the service increases, a higher work load of the service may be estimated. In addition, if an additional service is used, a higher work load may be estimated than when no additional service is used.

According to an embodiment of the present disclosure, a service usage priority for each client may be determined according to the estimated work load. For example, when client A uses a service, for example, reproduction of multimedia contents, more often than client B, a work load of client A may be estimated to be higher than that of the client B, and a service usage priority of client A may be determined to be higher than that of client B.

For example, in a hybrid cloud environment, if client A may use a multimedia contents replay service at least four days a week, and client B uses the multimedia contents replay service two days a week, at most, a usage frequency of the multimedia contents replay service of client A is higher than that of client B, and thus, a usage priority of the multimedia contents replay service of the client A may be determined to be higher than that of client B.

The service usage priority for each client may be linked with a billing service and may be determined in the above-described manner, and/or may be determined according to a policy according to use time, a needed amount of traffic, and/or whether an additional service is used, which will be described later. In addition, a work load of a service may be estimated based on use time information from among factors for determining a service use pattern of a client.

In the above example of the multimedia contents replay service, if client A uses the service at least 12 hours a day, client B uses the service less than three hours a day, and client C uses the service 7 hours or less a day, then a higher work load may be estimated when the service use time is greater. That is, a lower work load may be estimated in a descending order of clients A, C, and B. Also, the service use time information of a client may be obtained based on a daily basis and/or on a periodic basis, such as a week, a month, a year, or another similar and/or suitable period of time.

The service usage priority may be determined in the order of clients A, C, and B according to the order of the estimated work load. In other words, the service usage priority of client A may be the highest for the multimedia contents replay service, and the service usage priority of client B may be determined to be the lowest.

In addition, a work load of a service may be determined based on a needed amount of traffic from among factors for determining a service use pattern of a client. For example, a work load may be estimated and a service usage priority may be determined according to a descending order of higher amount of data transmission and reception traffic, in order to execute a service, from among a plurality of clients.

Data transmission and reception traffic may include data transmission and reception traffic between a service included in a hybrid cloud environment, e.g., the private cloud server 1000 or the public cloud server 2000, and a client, data transmission and reception traffic in the private cloud server 1000, data transmission and reception traffic in the public cloud server 2000, and data transmission and reception traffic between at least one of the private cloud server 1000 and the public cloud server 2000 and the hybrid cloud controlling apparatus 3000.

For example, if a needed amount of traffic between client C and a server included in a hybrid cloud environment is the highest, and the needed amount of traffic decreases in the order of a client B and a client A, a higher service usage priority may be determined in a descending order of needed amounts of traffic. That is, the higher service usage priority is in the descending order of client C, client B, and client A.

Also, a service usage priority of a client may be determined according to whether an additional service is used, from among factors for determining a service use pattern of a client. For example, in a case where client C, from among clients A, B, and C, uses an additional service, a service usage priority of client C may be determined to be higher than those of clients A and B.

In addition, according to an embodiment of the present disclosure, a service usage priority of a client may be determined by applying a weight on at least one of use frequency information, use time information, a needed amount of traffic, and information about whether an additional service is used.

For example, a highest weight may be applied to the information about whether an additional service is used, and this weight may be used in determining a service usage priority of a client. Also, a smaller weight may be applied to the order of the needed amount of traffic, service use time information, and service use frequency information and may be used in determining a service usage priority of a client, but the order in which weights are applied is not limited thereto. The order of applying the weights may be determined differently according to a policy of operating a hybrid cloud environment.

In the above-described example, although service use time of client A, per day, is far higher than that of client C, client C uses an additional service, and thus, a usage priority of client C may be higher than that of client A according to information on whether an additional service with a higher weight is applied.

In addition, similarly, although service use time of client A, per day, is far higher than that of client B, a needed amount of traffic of client B is higher than that of client A, and thus, a usage priority of client B may be higher than that of client A according to the needed amount of traffic to which a higher weight is applied compared to the service use time information.

FIG. 5 illustrates a method of distributing service-related data based on an estimated work load according to an embodiment of the present disclosure.

Referring to FIG. 5, operation S400 of the distributing of the data related to the service, which may also be referred to as service-related data, based on the estimated work load may include operation S410 of allocating a position of the data related to the service to one of a private cloud and a public cloud of the hybrid cloud environment according to a priority, and operation S420 of moving data related to the service, according to the allocated position.

Referring to FIG. 1, the hybrid cloud controlling apparatus 3000 may allocate a position of service-related data such that a service requested by a client is executed in one of the private cloud server 10000 and the public cloud server 2000 according to a service usage priority of a client.

For example, in order that a service requested by a client, whose service use frequency is relatively high, for example, a client having a relatively high priority from among a plurality of clients, is executed in a cloud server where a relatively small work load is consumed, the hybrid cloud controlling apparatus 3000 may allocate a position of the service-related data to a cloud server where a relatively small work load is consumed.

For example, a cloud server where a relatively small work load is consumed may include a server that is rich in, or in other words, has a large amount of available resources. Since a server capacity of the private cloud server 1000 may be easily extended and selective and flexible management of available resources thereof may be easy compared to the public cloud server 2000, a cloud server where a relatively small work load is consumed may be the private cloud server 1000.

In the above-described example, the hybrid cloud controlling apparatus 3000 may allocate a position of the service-related data to the private cloud server 1000 such that a service requested by a client having a relatively high priority may be executed in the private cloud server 1000.

In addition, the hybrid cloud controlling apparatus 3000 may allocate a position of second service-related data to the private cloud server 1000 such that a service requested by a client having a relatively high priority, e.g., a first service, and also a service requested by a client having a relatively low priority, e.g., a second service, is executed by using resources of the private cloud server 1000, in consideration of the available resources of the private cloud server 1000.

Service-related data may be moved between the private cloud server 1000 and the public cloud server 2000 according to position allocation of the service-related data by the hybrid cloud controlling apparatus 3000.

The service-related data may include personal information such as identification information of a user who has requested a service to be executed and/or service use history information indicating a service execution status. Also, the service-related data may include a VM for execution of a service.

Movement of the service-related data may include replication of data and data synchronization between the private cloud server 1000 and the public cloud server 2000.

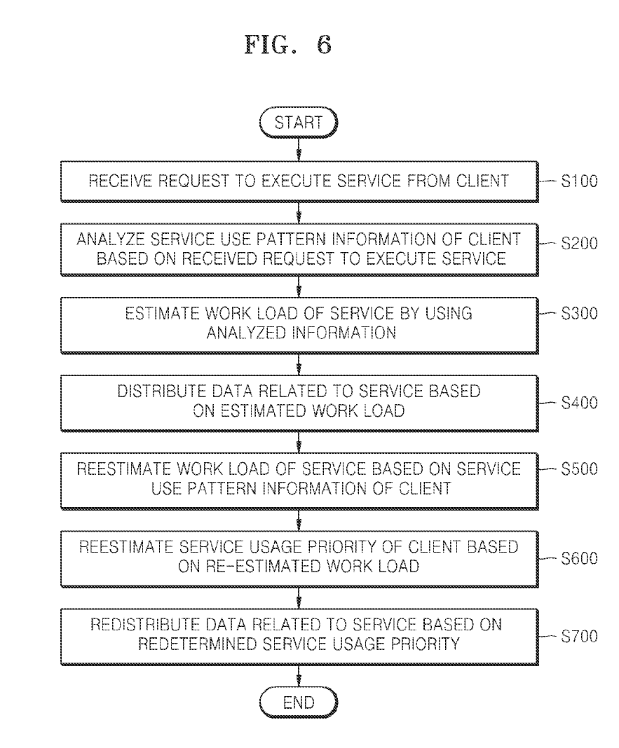

FIG. 6 is a flowchart illustrating a method of reestimating a work load and redistributing service-related data based on the reestimated work load according to an embodiment of the present disclosure.

Referring to FIG. 6, operations S100 through S400 are the same as those illustrated in FIG. 2, and thus, for the purpose of brevity, a separate description of operations S100 to S400 will not be made with reference to FIG. 6.

Referring to FIG. 6, the method of reestimating a work load and redistributing service-related data according to the current embodiment of the present disclosure may include: operation S500 of reestimating a work load of the service based on the service use pattern information of the client, operation S600 of reestimating the service usage priority of the client based on the reestimated work load, and operation S700 of redistributing the data related to the service based on the redetermined service usage priority.

In operation S500, the work load according to service uses for each client may be reestimated by determining service use pattern information for each client by using at least one of a service use frequency for each client, use time information, a required amount of traffic, information on whether an additional service is used, in period units.

The period units, according to the an embodiment of the present disclosure, may be, for example, 12 hours from a time when a request to execute a service is made, three days, a week, or any suitable amount of time from a date of a request to execute a service.

In operation S600, a service usage priority for each client may be redetermined based on the reestimated work load.

In operation S700, service-related data may be redistributed based on the redetermined service usage priority.

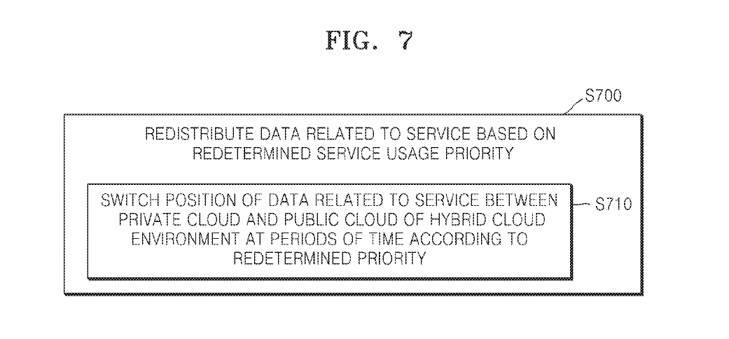

FIG. 7 illustrates a method of redistributing service-related data according to an embodiment of the present disclosure.

Referring to FIG. 7, operation S700 of the redistributing of the data related to the service based on the redetermined service usage priority may include operation S710 of switching a position of data related to the service between a private cloud and a public cloud of a hybrid cloud environment at periods of time according to the redetermined priority.

As described above, the periods of time, according to an embodiment of the present disclosure, may be, for example, 12 hours from a time when a request to execute a service is made, three days, a week, or any suitable amount of time from a date of a request to execute a service.

A position of the service-related data between the private cloud server 1000 and the public cloud server 2000 may be redistributed according to a service usage priority that is redetermined based on the work load according to service uses for each client that is reestimated in the periods of time.

For example, the work load after the request to execute a service for each client is made, may be changed as compared to the work load at the time when the request to execute a service is made, according to a service use state. For example, in the above-described example, after the request to execute a multimedia replay service is made by client A, if client A does not use the service for a period of time and/or requests to stop execution of the service, the service usage priority of client A may be adjusted.

For example, while client A is not using a service and/or sends a request to the hybrid cloud controlling apparatus 3000 to stop executing the service, if a new client D appears and requests execution of a multimedia replay service to the hybrid cloud controlling apparatus 3000, then the work load of client A may be reduced but a work load of client D may increase. Accordingly, service use priorities of client A and client D may be adjusted.

In other words, service-related data whose work load is reduced by client A may be moved from the private cloud server 1000 to the public cloud server 2000.

Also, in contrast, service-related data whose work load is increased by client D may also be moved from the public cloud server 2000 to the private cloud server 1000.

As described above, the hybrid cloud controlling apparatus 3000 may periodically reestimate the work load for each client, redetermine a service usage priority of each client, and redistribute service-related data.

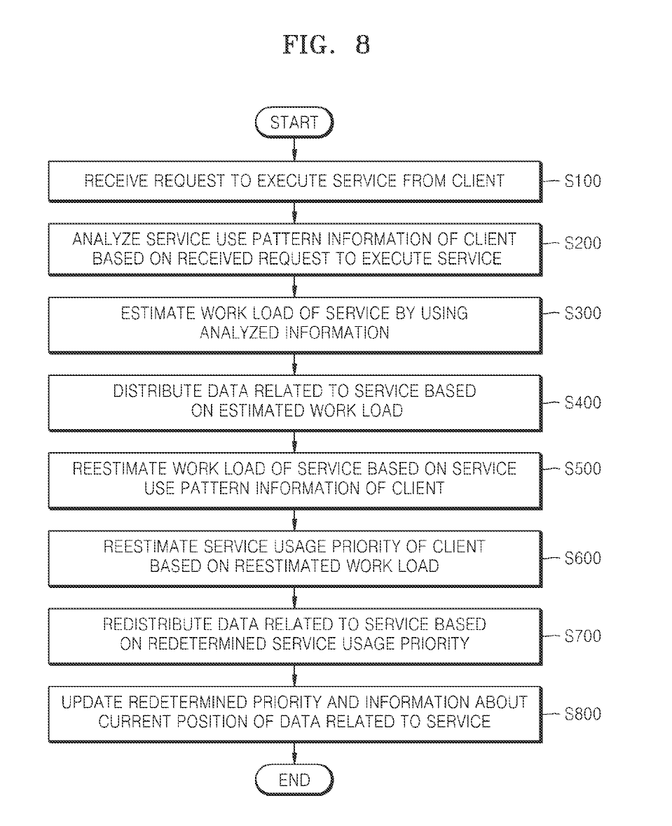

FIG. 8 is a flowchart illustrating a method of updating current position information of service-related data according to an embodiment of the present disclosure.

The method according to the embodiment of FIG. 6, which illustrates operations S100 to S700, may further include operation S800 of updating a redetermined priority and information about a current position of the service-related data.

The hybrid cloud controlling apparatus 3000 may monitor and update information about a service usage priority for each client and a current position of the service-related data in periods of time.

As described above, the updated information about the redetermined priority and the position of the service-related data may be used in distributing data.

The periods of time may be, for example, every thirty minutes or every hour or any suitable amount of time from the time when a service is requested to be executed.

For example, the hybrid cloud controlling apparatus 3000 may store information about a service use state for each client that is obtained by monitoring in periods of time, according to identification information of each client, e.g., an Identifier (ID). For example, as shown in Table 1 below, information about a service usage priority for each client, identification information for each client, service types, a current service status, a position of service-related data may be stored in the form of a table, but is not limited thereto.

TABLE 1

| | | | current | position of |
|---|---|---|---|---|
| current | identification | | service | service- |
| priority | information | service type | status | related data |
| 4 | Client_A | multimedia replay | execution | Pub_Server |
| | | service | completed | |
| 2 | Client_B | data search service | being | Pri_Server |
| | | | executed | |
| 3 | Client_C | document | execution | Pri_Server |
| | | composition service | complete | |
| 1 | Client_D | multimedia replay | being | Pri_Server |
| | | service | executed | |

The hybrid cloud controlling apparatus 3000 may allow a client, which has completed service execution and requested a service to be executed, to directly connect to a cloud server at which service-related data is located, by using a monitoring result regarding a service status for each client as described above, thereby enabling quick service execution compared to the conventional art.

For example, when client C requests the hybrid cloud controlling apparatus 3000 to execute a document composition service to re-execute a document composition service which has been completed before, the hybrid cloud controlling apparatus 3000 may determine whether data related to the document composition service is currently stored in the private cloud server 1000 in order to connect client C to the private cloud server 1000.

In addition, if a priority for each client is redetermined, a service that is requested to be executed, and that is requested by clients corresponding to middle priorities from among the redetermined priorities, may be executed in any of the private cloud server 1000 and the public cloud server 2000.

Accordingly, a portion of data, e.g., identification information of a client, related to a service that is requested by clients of the middle priorities to be executed, may be replicated and located in both the private cloud server 1000 and the public cloud server 2000 to thereby quickly respond to a request by the client to execute the service. By partial replication and distribution of service-related data, service latency may be minimized.

Also, a portion of data, e.g., identification information of a client, related to a service requested by the clients of the middle priorities, to be executed, may be replicated in a cache to thereby prevent an increase in a needed amount of traffic which may be frequently caused between servers according to execution of a service of a client.

In addition, in regard to partial replication and/or distribution of service-related data, when execution of a service is ended and/or connection of a client to a service is ended, e.g., logout, the replicated data may be synchronized with the private cloud server 1000 and the public cloud server 2000 and stored in the private cloud server 1000 to thereby maintain latest service-related data for each client.

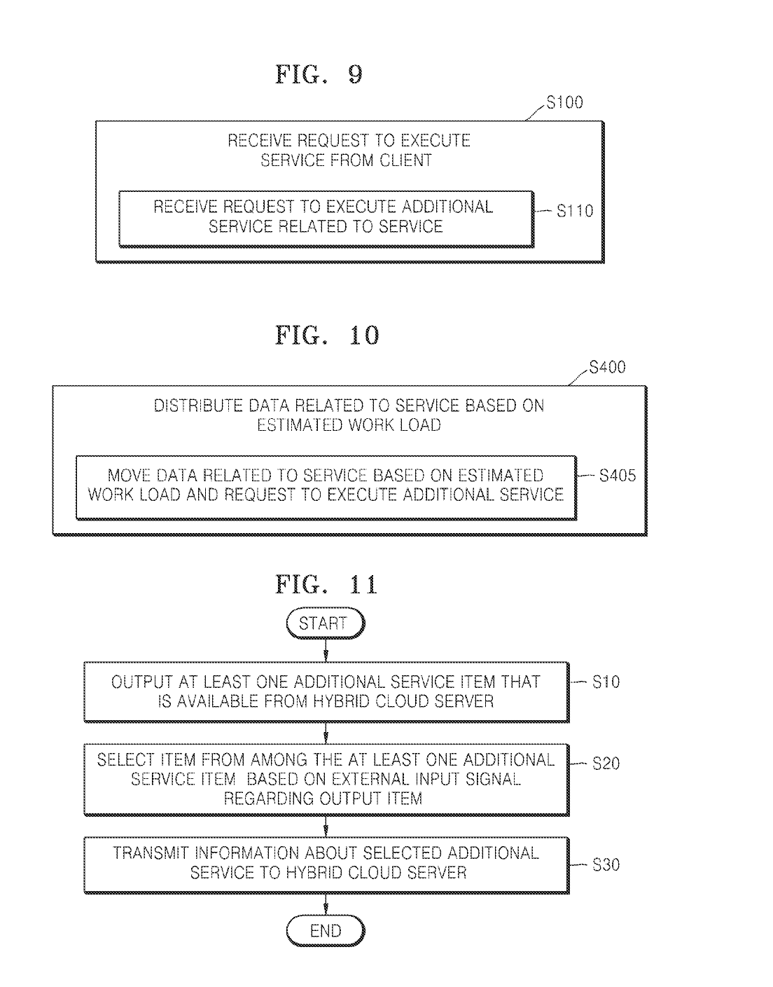

FIG. 9 illustrates a method of receiving a request to execute a service, from a client according to an embodiment of the present disclosure.

Referring to FIG. 9, operation S100 of the receiving of the request to execute the service, from a client, may further include operation S110 of receiving a request to execute an additional service related to the service.

The additional service may include a service regarding at least one of selection of a security level, selection of a position where a service is to be executed, selection of a number of pieces of duplicate data, selection of performance of a server where a service is to be executed, and selection of a network speed.

The client may select a security level of the service-related data. If a relatively high security level is selected compared to a basic security level, e.g., a default level, provided in a hybrid cloud environment, the client may store a plurality of pieces of replicate data of the service-related data in the private cloud server 1000.

For example, when the client has selected a reinforced security level, at least three pieces of replicate data, such as service-related data, may be generated and stored in the private cloud server 1000 for a period of time.

In addition, the client may select a position, or in other words, may select a location where a service is to be executed, from among the private cloud server 1000 and the public cloud server 2000.

For example, when client A selects the public cloud server 2000 as the position, i.e., the location, to execute a service, the service requested by client A may be executed in the public cloud server 2000 regardless of a service usage priority of client A.

In addition, the client may select a number of pieces of replicate data to be stored in the private cloud server 1000. In terms of the example of selection of the security level described above, the client may select a number of pieces of replicate data to replicate three, four, or n pieces of data to be stored in the private cloud server 1000. Also, the client may select a memory space such that a desired memory space may be provided in the private cloud server 1000.

In addition, the client may select performance of a server to execute a service. Server performance may vary according to a method of utilizing available resources of a server. Accordingly, the client may select performance of a server where its service is to be executed.

In addition, the client may select a network speed. For example, the client may select a data transmission and reception speed or the like between the client and the server, e.g., the private cloud server 1000 or the public cloud server 2000.

A fee may be imposed on the client which is to execute the additional service described above, through a connection with a billing system. For example, a fee determined in advance according to a type of an additional service and/or a service option, e.g., data storage period and/or data storage space, in a hybrid cloud environment may be imposed on a client which uses a corresponding additional service.

FIG. 10 illustrates a method of distributing service-related data based on a request to execute an additional service according to an embodiment of the present disclosure.

Referring to FIG. 10, operation S400 of the distributing of the data related to the service based on the estimated work load may include operation S405 of moving data related to the service based on the estimated work load and the request to execute an additional service.

The service-related data may be moved between the private cloud server 1000 and the public cloud server 2000 according to the service usage priority determined based on the work load as described above and the request to execute an additional service.

For example, if a client, whose service usage priority is relatively low and which is executing a service in the public cloud server 2000, selects a reinforced security level as an additional service, the service-related data of the client which is executing a service in the public cloud server 2000 may be replicated to a plurality of pieces of data and may be stored in the private cloud server 1000 for a period of time. In this case, the plurality of the pieces of replicated data may be moved from the public cloud server 2000 to the private cloud server 1000. Also, after the service-related data is moved from the public cloud server 2000 to the private cloud server 1000, another plurality of pieces of replicate data may be generated in the private cloud server 1000 and stored therein.

In addition, as described above, the client may select a position, i.e., a location, to execute a service, from among the private cloud server 1000 and the public cloud server 2000.

For example, if client A selects the public cloud server 2000 to execute a service, service-related data may be located in the public cloud server 2000 such that the service requested by client A may be executed in the public cloud server 2000 regardless of a service usage priority of client A. If service-related data of client A has been located in the private cloud server 1000 before, then the hybrid cloud controlling apparatus 3000 may move the service-related data from the private cloud server 1000 to the public cloud server 2000 according to a request by the client A to execute an additional service, e.g., a request to designate a position to execute a service.

FIG. 11 is a flowchart illustrating a method of distributing data according to selection of a client in a hybrid cloud environment according to an embodiment of the present disclosure.

Referring to FIG. 11, the method of distributing data according to selection of a client in a hybrid cloud environment may include: operation S10 of outputting at least one additional service item that is available from a hybrid cloud server, operation S20 of selecting an item from among the at least one additional service item based on an external input signal regarding the output item, and operation S30 of transmitting information about the selected additional service to the hybrid cloud server. The hybrid cloud server may distribute data based on the information received from the client.

The hybrid cloud server may be the hybrid cloud controlling apparatus and/or data distributing apparatus 3000.

The additional service may include a service regarding at least one of selection of a security level, selection of a position or a location where a service is to be executed, selection of a number of pieces of duplicate data, selection of performance of a server where a service is to be executed, and selection of a network speed. The additional service has been described above.

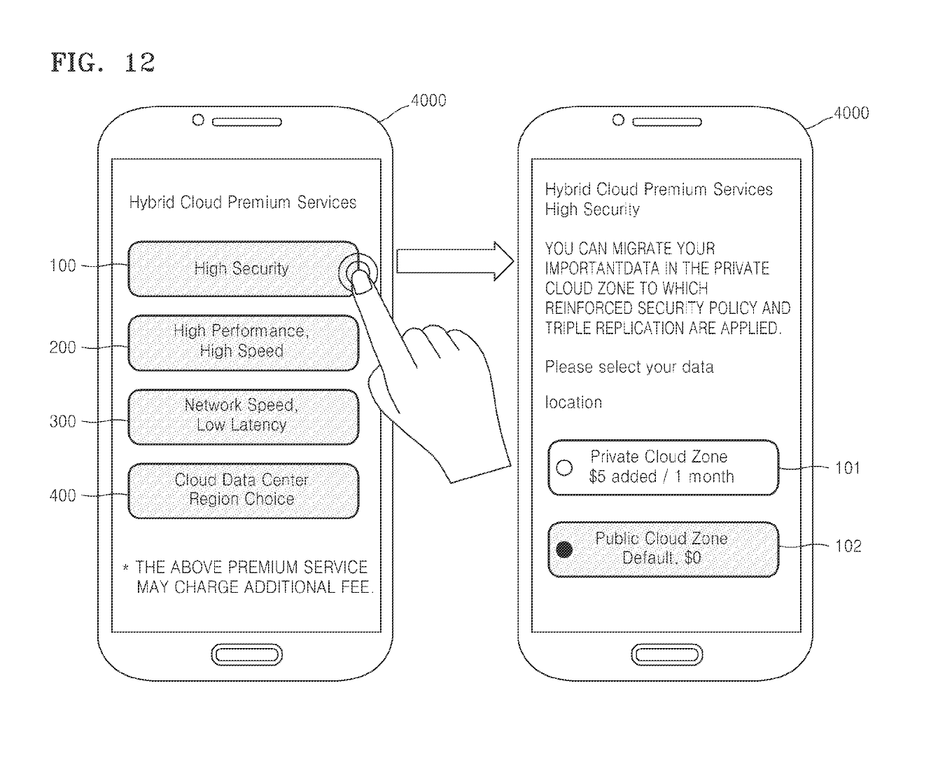

FIG. 12 illustrates an example of an additional service available via a client, in a hybrid cloud environment according to an embodiment of the present disclosure.

Referring to FIG. 12, the at least one additional service item is provided as at least one of a character, an image, and sound.

An item of an additional may be provided via the client 4000, which may be a mobile terminal. As illustrated in FIG. 12, an item of an additional service may be a security level 100, performance of a server 200 where a service is to be executed, a network speed 300, and a position to execute a service 400, and any of the items of the additional service may be selected by a user.

When an additional service is selected based on an external input signal, e.g., a selection signal, such as a touch input, a key input, or any other similar and/or suitable input of a user, with respect to one of a plurality of items output through the client 4000, a specific item 101 and/or 102 included in the selected additional service may be provided additionally. The specific item may include information used in connecting with a billing system, e.g., information indicating that an amount of money, i.e., a service fee, is imposed on a client.

Also, at least one additional service item may be provided as at least one of a character and an image, or as sound via an audio signal such as voice.

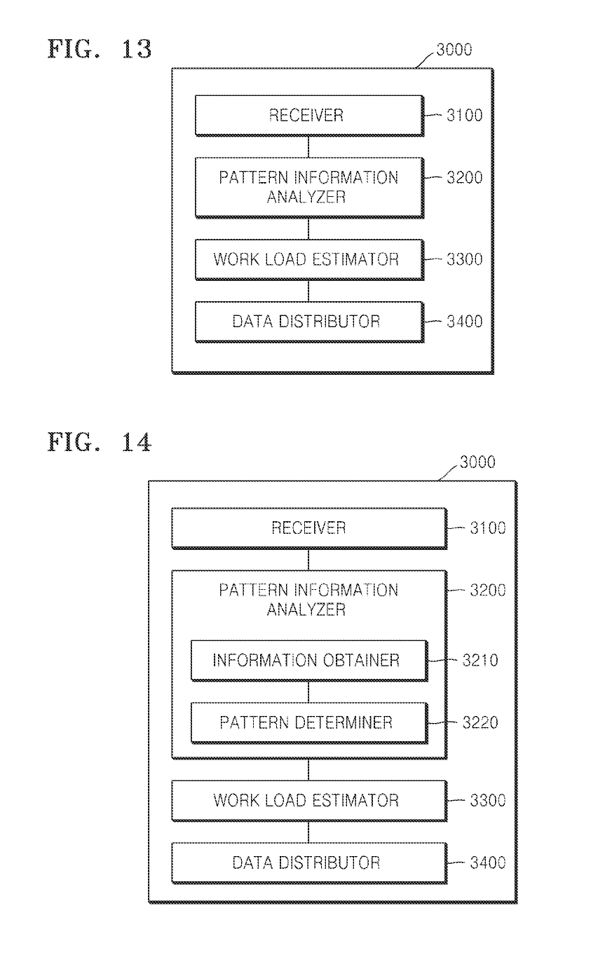

FIG. 13 is a block diagram illustrating an apparatus for distributing data in a hybrid cloud environment according to an embodiment of the present disclosure.

Referring to FIG. 13, the hybrid cloud controlling apparatus 3000, which may also be referred to as the data distributing apparatus 3000, for distributing data in a hybrid cloud environment, may include: a receiver 3100 configured to receive a request to execute a predetermined service from a client, a pattern information analyzer 3200 configured to analyze service use pattern information of the client based on the received request to execute a service, a work load estimator 3300 configured to estimate a work load of the service by using the analyzed information, and a data distributor 3400 configured to distribute data related to the service based on the estimated work load.

As described above, a request to execute a predetermined service, sent from a client, may be received by the receiver 3100 in the form of an electromagnetic wave signal in a wired and/or wireless manner.

Also, the hybrid cloud controlling apparatus 3000 may further include a transmitter (not shown) that transmits a signal to the private cloud server 1000, the public cloud server 2000, and the client 4000. Also, the transmitter may transmit a control signal for moving data generated by using the data distributor 3400, to the private cloud server 1000 and/or the public cloud server 2000.

In addition, the transmitter and the receiver 3100 may be implemented as a single-type component, such as a transceiver, having a transmitting function and a receiving function or as separate and individual components, that is, a transmitter having a transmitting function and a receiver having a receiving function.

In addition, the hybrid cloud controlling apparatus 3000 may include a storage unit (not shown) that stores use frequency information of the service by the client, usage time information, a required amount of traffic, information about whether an additional service is used, and any other similar and/or suitable information for each client, which will be described later.

FIG. 14 is a block diagram illustrating an apparatus including a pattern information analyzer according to an embodiment of the present disclosure.

Referring to FIG. 14, the pattern information analyzer 3200 may include: an information obtainer 3210 configured to obtain at least one of use frequency information of the service by the client, usage time information, a needed amount of traffic, and information about whether an additional service is used or not, and a pattern determiner 3220 configured to determine a use pattern of the service by the client based on the obtained information.

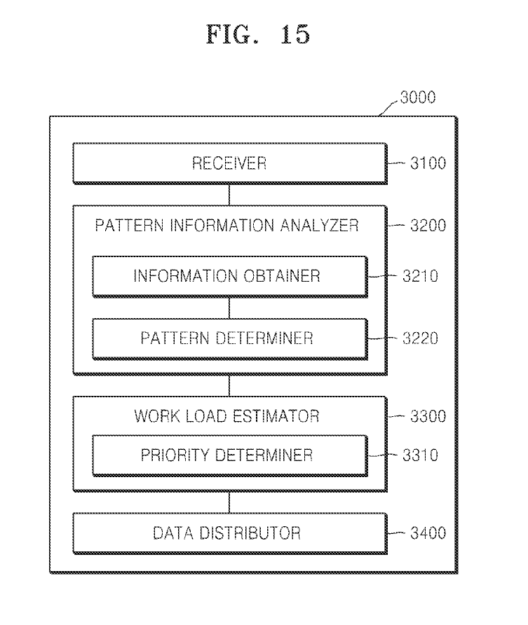

FIG. 15 is a block diagram illustrating an apparatus including a work load estimator according to an embodiment of the present disclosure.

Referring to FIG. 15, the work load estimator 3300 may estimate a work load of a service that is requested to be executed, based on the determined use pattern. The work load estimator 3300 may further include a priority determiner 3310 configured to determine a service usage priority of the client based on the estimated work load.

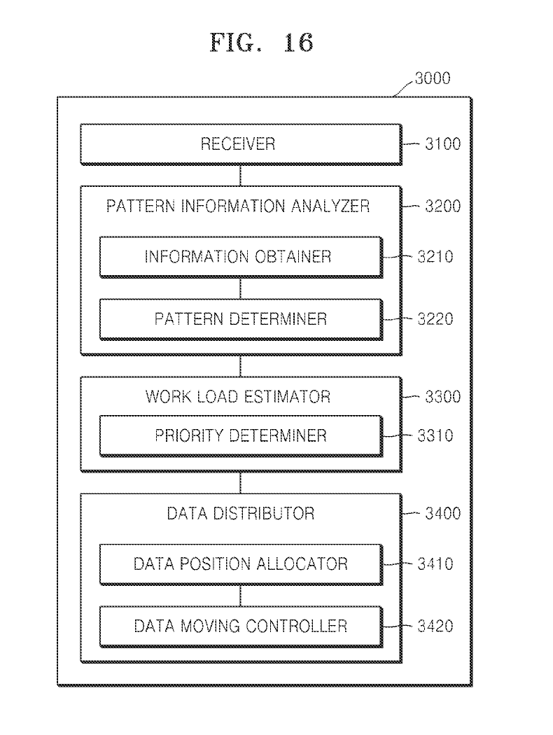

FIG. 16 is a block diagram illustrating an apparatus including a data distributor according to an embodiment of the present disclosure.

Referring to FIG. 16, the data distributor 3400 may include a data position allocator 3410 configured to allocate a position and/or a location of the data related to the service to one of a private cloud and a public cloud of a hybrid cloud environment according to the determined priority, and a data moving controller 3420 for moving data related to the service, according to the allocated position.

The data position allocator 3410 may allocate a position of service-related data to one of the private cloud server 1000 and the public cloud server 2000 according to a priority determined by using a priority determiner 3310.

The data moving controller 3420 may generate a control signal for moving service-related data according to the position allocated by using the data position allocator 3410. The generated control signal may be transmitted to the private cloud server 1000 or the public cloud server 2000.

Also, the work load estimator 3300 may reestimate a work load of the service based on the service use pattern information of the client 4000 in predetermined periods.

Also, the priority determiner 3310 may redetermine the service usage priority of the client based on the reestimated work load.

Also, the data distributor 3400 may switch a position of the data related to the service between the private cloud and the public cloud of the hybrid cloud environment in predetermined periods according to the redetermined priority.

Also, the receiver 3100 may receive a request to execute an additional service related to the service, from the client 4000.

The additional service may include a service regarding at least one of selection of a security level, selection of a position or a location where a service is to be executed, selection of a number of pieces of duplicate data, selection of performance of a server where a service is to be executed, and selection of a network speed.

Also, the data distributor 3400 may move the data related to the service in the hybrid cloud environment based on the estimated work load that is estimated by using the work load estimator 3300 and the request to execute the additional service, received from the client 4000 via the receiver 3100.

FIG. 17 is a block diagram illustrating an apparatus including a position information updating unit according to an embodiment of the present disclosure.

Referring to FIG. 17, the hybrid cloud controlling apparatus 3000, which may also be referred to as the data distributing apparatus 3000, may further include a position information updating unit 3500 configured to update the priority redetermined by using the priority determiner 3310 and information about a current position of data related to a service that is requested to be executed.

The information about a current position of data related to the service that is requested to be executed may be monitored in real time by using the data distributor 3400. The monitored information and the priority that is redetermined by using the priority determiner 3310 may be maintained as latest data by using the position information updating unit 3500.

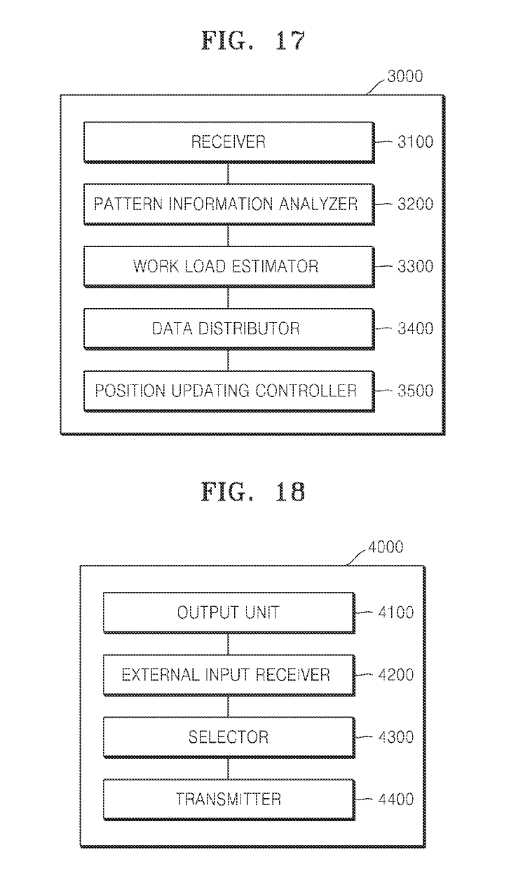

FIG. 18 is a block diagram illustrating a client that provides an additional service related to data distribution on the side of a server in a hybrid cloud environment according to an embodiment of the present disclosure.

The client 4000 providing an additional service related to data distribution on the side of a server in a hybrid cloud environment, includes: an output unit 4100 configured to output at least one additional service item that is available from a hybrid cloud server, an external input receiver 4200 configured to receive an external input signal about the output item, a selector 4300 configured to select an item among the at least one additional service item based on the received external input signal, and a transmitter 4400 configured to transmit information about the selected additional service to the hybrid cloud server and to transmit any other information and/or data to be transmitted from the client 4000 to another electronic device, and may further include a receiver (not shown) configured to receive any information and/or data to be received by the client 4000 from an electronic device.

The data related to a service that is requested to be executed, by the client, may be distributed on the side of the server based on the information about the selected additional service.

The hybrid cloud server according to an embodiment of the present disclosure may be the hybrid cloud controlling apparatus 3000 which may also be referred to as the data distributing apparatus 3000.

The additional service may include a service regarding at least one of selection of a security level, selection of a position where a service is to be executed, selection of a number of pieces of duplicate data, selection of performance of a server where a service is to be executed, and selection of a network speed.

The at least one additional service item may be provided as at least one of a character, an image, and sound.

The description related to the above-described method may be applied to an apparatus according to an embodiment of the present disclosure. Thus, the description of the apparatus as described with reference to the above-described method will not be repeated here.

The various embodiments of the present disclosure may be written as computer programs that may be implemented in general-use digital computers that execute the programs using a computer readable recording medium.

Examples of the computer readable recording medium include magnetic storage media, e.g., a Read Only Memory (ROM), floppy disks, hard disks, etc., optical recording media, e.g., Compact Disk-ROMs (CD-ROMs_, Digital Versatile Disks (DVDs), etc., and storage media such as carrier waves, e.g., transmission through the Internet.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile, non-volatile, or non-transitory storage medium, such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of distributing data in a hybrid cloud environment, the method comprising:
receiving a request to execute a service from a client;
analyzing service use pattern information of the client based on the received request to execute the service;
estimating a work load of the service by using the analyzed service use pattern information; and
distributing data related to the service based on the estimated work load.

2. The method of claim 1, wherein the analyzing of the service use pattern information of the client based on the received request to execute a service comprises:
obtaining information that is at least one of use frequency information of the service by the client, usage time information, a needed amount of traffic, and information about whether an additional service is used; and
determining a use pattern of the service by the client based on the obtained information.

3. The method of claim 2, wherein the estimating of the work load of the service by using the analyzed service use pattern information comprises:
estimating a work load of the service which is requested to be executed, based on the determined use pattern; and
determining a service usage priority of the client based on the estimated work load.

4. The method of claim 3, wherein the distributing of the data related to the service based on the estimated work load comprises:
allocating a position of the data related to the service to one of a private cloud of the hybrid cloud environment and a public cloud of the hybrid cloud environment according to the determined priority; and
moving data related to the service according to the allocated position of the data.

5. The method of claim 1, further comprising:
reestimating the work load of the service based on the service use pattern information of the client;
reestimating the service usage priority of the client based on the reestimated work load; and
redistributing the data related to the service based on the redetermined service usage priority.

6. The method of claim 5, wherein the redistributing of the data related to the service based on the redetermined service usage priority comprises switching a position of data related to the service between the private cloud and the public cloud of the hybrid cloud environment in periods of time according to the redetermined priority.

7. The method of claim 6, further comprising updating the redetermined priority and information about a current position of the data related to the service.

8. The method of claim 2, wherein the receiving of the request to execute the service from the client further comprises receiving a request to execute an additional service related to the service.

9. The method of claim 8, wherein the additional service comprises a service regarding at least one of selection of a security level, selection of a position where a service is to be executed, selection of a number of pieces of duplicate data, selection of performance of a server where a service is to be executed, and selection of a network speed.

10. The method of claim 9, wherein the distributing data related to the service based on the estimated work load comprises moving data related to the service based on the estimated work load and the request to execute the additional service.

11. A method of distributing data according to selection by a client in a hybrid cloud environment, the method comprising:
outputting at least one additional service item that is available from a hybrid cloud server;
selecting an additional service from among the outputted at least one additional service item based on an external input signal corresponding to the outputted at least one additional service item; and
transmitting information about the selected additional service to the hybrid cloud server,
wherein the hybrid cloud server distributes data based on the information received from the client.

12. The method of claim 11, wherein the outputted at least one additional service comprises a service regarding at least one of selection of a security level, selection of a position where a service is to be executed, selection of a number of pieces of duplicate data, selection of performance of a server where a service is to be executed, and selection of a network speed.

13. The method of claim 11, wherein the outputted at least one additional service item is provided as at least one of a character, an image, and sound.

14. An apparatus for distributing data in a hybrid cloud environment, the apparatus comprising:
a receiver configured to receive a request to execute a service from a client;
a pattern information analyzer configured to analyze service use pattern information of the client based on the received request to execute the service;
a work load estimator configured to estimate a work load of the service by using the analyzed service use pattern information; and
a data distributor configured to distribute data related to the service based on the estimated work load.

15. The apparatus of claim 14, wherein the pattern information analyzer comprises:
an information obtainer configured to obtain information that is at least one of use frequency information of the service by the client, usage time information, a needed amount of traffic, and information about whether an additional service is used; and
a pattern determiner configured to determine a use pattern of the service by the client based on the obtained information.

16. The apparatus of claim 15, wherein the work load estimator is configured to estimate the work load of a service that is requested to be executed based on the determined use pattern,
wherein the work load estimator further comprises a priority determiner configured to determine a service usage priority of the client based on the estimated work load.

17. The apparatus of claim 16, wherein the data distributor comprises:
a data position allocator configured to allocate a position of the data related to the service to one of a private cloud of the hybrid cloud environment and a public cloud of the hybrid cloud environment according to the determined priority; and
a data moving controller configured to move data related to the service, according to the allocated position of the data.

18. The apparatus of claim 17, wherein the work load estimator is configured to reestimate the work load of the service based on the service use pattern information of the client in predetermined periods, and
wherein the priority determiner is configured to redetermine the service usage priority of the client based on the reestimated work load.

19. The apparatus of claim 18, wherein the data distributor is configured to switch a position of the data related to the service between the private cloud and the public cloud of the hybrid cloud environment in periods of time according to the redetermined priority.

20. The apparatus of claim 19, further comprising a position information updating unit configured to update the redetermined priority and information about a current position of the data related to the service.

21. The apparatus of claim 16, wherein the receiver is configured to receive a request to execute an additional service related to the service.

22. The apparatus of claim 21, wherein the additional service comprises a service regarding at least one of selection of a security level, selection of a position where a service is to be executed, selection of a number of pieces of duplicate data, selection of performance of a server where a service is to be executed, and selection of a network speed.

23. The apparatus of claim 22, wherein the data distributor is configured to move the data related to the service based on the estimated work load based on the request to execute the additional service.

24. A client providing an additional service related to data distribution on the side of a server in a hybrid cloud environment, the client comprising:
an output unit configured to output at least one additional service item that is available from a hybrid cloud server;
an external input receiver configured to receive an external input signal corresponding to the outputted at least one additional service item;
a selector configured to select an additional service from among the outputted at least one additional service item based on the received external input signal; and
a transmitter configured to transmit information about the selected additional service to the hybrid cloud server,
wherein the data is distributed by the hybrid cloud server based on the information about the selected additional service.

25. The client of claim 24, wherein the outputted at least one additional service comprises a service regarding at least one of selection of a security level, selection of a position where a service is to be executed, selection of a number of pieces of duplicate data, selection of performance of a server where a service is to be executed, and selection of a network speed.

26. The client of claim 24, wherein the outputted at least one additional service item is provided as at least one of a character, an image, and sound.

27. A non-transitory computer readable recording medium having stored thereon a program for executing the method of claim 1.

28. A method of distributing data in a hybrid cloud environment including a public cloud and a private cloud, the method comprising:
receiving a request to execute a service from a client;
analyzing service use pattern information of the client based on the received request to execute the service;
estimating a work load of the service by using the analyzed service use pattern information; and
distributing data related to the service between the public cloud and the private cloud based on the estimated work load,
wherein the public cloud comprises a network service using a wide area network, and
wherein the private cloud comprises a network service using a local area network.
